(19) United States
(12) Patent Application Publication
(10) Pub. No.: US 2021/0005969 A1
(43) Pub. Date: Jan. 7, 2021

(54) CYLINDRICALLY PROFILED ULTRA-WIDE BAND ANTENNA

(71) Applicant: DRONESHIELD LTD., Sydney (AU)

(72) Inventors: Hedley Boyd-Moss, Brookfield (AU); David De Haaij, Trott Park (AU)

(21) Appl. No.: 16/916,802

(22) Filed: Jun. 30, 2020

Related U.S. Application Data
(60) Provisional application No. 62/869,338, filed on Jul. 1, 2019.

(51) Int. Cl. H01Q 13/08; H01Q 1/36

(52) U.S. Cl. CPC H01Q 13/085; H01Q 1/36

(57) ABSTRACT

A cylindrically-profiled ultra-wideband antenna is disclosed. In an example, an antenna apparatus includes a feed launch printed circuit board (“PCB”) assembly having a tapered slot opening into a round cavity section. The antenna apparatus also includes a cylindrically-profiled antenna body including a flat section and wings that are curved to form a semi-circular or cylindrical shape. The feed launch PCB assembly is co-planar with the flat section of the cylindrically-profiled antenna body. Additionally, the tapered slot is centered on the feed launch PCB assembly and aligned to match a mirrored tapered slot of the cylindrically-profiled antenna body. The combination of the feed launch PCB assembly and the cylindrically-profiled antenna body provides a radiation bandwidth between 850 MHz and 6 GHz.

### PRIORITY CLAIM

This application claims priority to and the benefit as a non-provisional application of U.S. Provisional Patent Application No. 62/869,338, filed Jul. 1, 2019, the entire contents of which are hereby incorporated by reference and relied upon.

### BACKGROUND

Vivaldi antennas are well-known, co-planar broadband antennas for ultra-wideband receiving and or transmitting applications. Typically, a Vivaldi antenna has a tapered slot that is connected to a space defined by an opening in two symmetrically conductive wings of a single electrically conductive copper sheet (e.g., a radiator). A feed line or microstrip is placed across a coupling slot that is located between the two symmetrical sheets.

Vivaldi antennas are desirable because they are relatively compact (e.g., low profile) and lightweight compared to other antennas for ultra-wideband (“UWB”) applications. For instance, Vivaldi antennas are commonly used for short-range, high-bandwidth communications. The antennas have a relatively high directivity across a full frequency band of operation. The relatively straightforward design makes Vivaldi antennas efficient to fabricate. However, Vivaldi antennas are not common for applications at frequencies less than 2.5 GHz.

### SUMMARY

A cylindrically-profiled ultra-wideband antenna is disclosed herein. The antenna includes a Feed Launch PCB Assembly (“FLPCBA”) and a Cylindrically Profiled Antenna Body (“CPAB”). The example FLPCBA described herein is uniquely designed for manufacturability as to maintain tight mechanical and electrical tolerances for the feed launch aspects of the antenna. The FLPCBA includes two printed circuit board (“PCB”). A first PCB is provided as a support. A second PCB included etched copper to form a feed launch. The PCBs include a high dielectric strength high frequency printed circuit board material that is copper clad and etched for achieving precision tolerances for a feed from an unbalanced feeder and mirror launch into the CPAB. This configuration ensures small manufacturing tolerances are maintained keeping within the tight electrical tolerances required for impedance matching across a wide frequency band.

The ultra-wideband antenna disclosed herein includes a CPAB connected to or integrated with a FLPCBA. Together, the FLPCBA and the cylindrically-profiled antenna body form a cylindrically profiled ultra-wide band antenna. The disclosed antenna has a high-frequency capability (e.g., 2.4 GHz to 6.0+ GHz) that is similar to known Vivaldi antennas in addition to a low-frequency capability (less than 2.4 GHz). The disclosed cylindrically-profiled ultra-wideband antenna accordingly provides an effective operating frequency from less than 1 GHz upwards to 6 GHz.

The cylindrically-profiled ultra-wideband antenna disclosed herein is part of a countermeasure system for unmanned aerial vehicles (“UAVs”), such as hobbyist, commercial or military drones. Specifically, the disclosed cylindrically-profiled ultra-wideband antenna is configured to emit an electromagnetic signal or wave to interrupt and/or disrupt radio frequency (“RF”) communications of UAVs. The cylindrically-profiled ultra-wideband antenna may also interrupt and/or disrupt reception of Global Navigation Satellite System (GNSS) Global Positioning System (“GPS”) signals by UAVs. Interruption and/or disruption of UAV communications and/or (GNSS) signals typically cause UAVs to land or return to an operator, thereby aborting its mission.

In addition to providing active countermeasures, the example cylindrically-profiled ultra-wideband antenna may also be used to detect UAVs. For example, the cylindrically-profiled ultra-wideband antenna may be connected to an RF receiver configured to detect a presence of UAVs through reception of RF signals of the UAV in the 850 MHz to 6 GHz frequency range. In some instances, after detection, the cylindrically-profiled ultra-wideband antenna disclosed herein is configured to emit a relatively high-frequency electromagnetic signal or wave to counter the detected UAV.

Aspects of the subject matter described herein may be useful alone or in combination with one or more other aspect described herein. Without limiting the foregoing description, in a first aspect of the present disclosure, an antenna apparatus includes a coaxial feed launch PCB assembly having a tapered slot opening into a round cavity section. The tapered slot is centered on the PCB and aligned to match a mirrored tapered slot of a cylindrically-profiled antenna body. The feed launch PCB assembly is co-planar with the flat section of the cylindrically-profiled antenna body. The cylindrically-profiled antenna body also includes wings that are curved to form a semi-circular or cylindrical shape.

In accordance with a second aspect of the present disclosure, which may be used in combination with any other aspect listed herein unless stated otherwise, the feed launch PCB assembly includes two PCBs that sandwich the corresponding mirrored image of the tapered slot and fastened into position by fasteners lining an edge of the PCB assembly.

In accordance with a third aspect of the present disclosure, which may be used in combination with any other aspect listed herein unless stated otherwise, the feed launch PCB assembly includes a first PCB and a second PCB that sandwich at least a portion of the flat section of the cylindrically-profiled antenna body.

In accordance with a fourth aspect of the present disclosure, which may be used in combination with any other aspect listed herein unless stated otherwise, the tapered slot and the round cavity section are formed from etched copper on at least one of the first PCB and the second PCB.

In accordance with a fifth aspect of the present disclosure, which may be used in combination with any other aspect listed herein unless stated otherwise, the first PCB is connected to the second PCB via fasteners positioned along at least one edge of the feed launch PCB assembly.

In accordance with a sixth aspect of the present disclosure, which may be used in combination with any other aspect listed herein unless stated otherwise, the fasteners are non-conductive.

In accordance with a seventh aspect of the present disclosure, which may be used in combination with any other aspect listed herein unless stated otherwise, the tapered slot of the feed launch PCB assembly is defined by two symmetrical wings that are co-planar with the round cavity section.

In accordance with an eighth aspect of the present disclosure, which may be used in combination with any other aspect listed herein unless stated otherwise, the apparatus further comprises a feedline electrically connected to the feed launch PCB assembly.

In accordance with a ninth aspect of the present disclosure, which may be used in combination with any other aspect listed herein unless stated otherwise, the feedline is additionally connected to a source of radio-frequency (“RF”) energy.

In accordance with a tenth aspect of the present disclosure, which may be used in combination with any other aspect listed herein unless stated otherwise, the feedline includes a coaxial feeder cable.

In accordance with an eleventh aspect of the present disclosure, which may be used in combination with any other aspect listed herein unless stated otherwise, the combination of the feed launch PCB assembly and the cylindrically-profiled antenna body provides a radiation bandwidth between 850 MHz and 6 GHz.

In accordance with a twelfth aspect of the present disclosure, which may be used in combination with any other aspect listed herein unless stated otherwise, an antenna apparatus comprises a feed launch assembly having a tapered slot and cylindrically-profiled antenna body including a flat section and wings that are curved to form a semi-circular or cylindrical shape, wherein the feed launch assembly is co-planar with the flat section of the cylindrically-profiled antenna body, and wherein the tapered slot of the feed launch assembly is aligned to match a tapered slot of the cylindrically-profiled antenna body.

In accordance with a thirteenth aspect of the present disclosure, which may be used in combination with any other aspect listed herein unless stated otherwise, the wings include a first wing having a first end connected to or integrally formed with the flat section and a second end with a first tab, and a second wing having a first end connected to or integrally formed with the flat section and a second end with a second tab.

In accordance with a fourteenth aspect of the present disclosure, which may be used in combination with any other aspect listed herein unless stated otherwise, the first tab of the first wing is mechanically connected to the second tab of the second wing.

In accordance with a fifteenth aspect of the present disclosure, which may be used in combination with any other aspect listed herein unless stated otherwise, the cylindrically-profiled antenna body has a diameter that is between 50 millimeters (“mm”) and 1000 mm and a length between 200 mm and 1000 mm.

In accordance with a sixteenth aspect of the present disclosure, which may be used in combination with any other aspect listed herein unless stated otherwise, the feed launch assembly includes a first rigid plate and a second rigid plate that sandwich at least a portion of the flat section of the cylindrically-profiled antenna body.

In accordance with a seventeenth aspect of the present disclosure, which may be used in combination with any other aspect listed herein unless stated otherwise, the tapered slot is formed from etched copper on at least one of the first rigid plate and the second rigid plate.

In accordance with an eighteenth aspect of the present disclosure, which may be used in combination with any other aspect listed herein unless stated otherwise, at least one of the first rigid plate and the second rigid plate includes a cavity section that is connected via an opening to the tapered slot.

In accordance with a nineteenth aspect of the present disclosure, which may be used in combination with any other aspect listed herein unless stated otherwise, the combination of the feed launch assembly and the cylindrically-profiled antenna body provides a radiation bandwidth between 850 MHz and 6 GHz.

In accordance with a twentieth aspect of the present disclosure, which may be used in combination with any other aspect listed herein unless stated otherwise, the apparatus further includes a feedline electrically connected to the feed launch assembly.

In accordance with a twenty-first aspect of the present disclosure, which may be used in combination with any other aspect listed herein unless stated otherwise, the feedline is electrically coupled to a drone detection and deterrent system.

In a twenty-second aspect of the present disclosure, any of the structure and functionality disclosed in connection with FIGS. 1 to 19 may be combined with any other structure and functionality disclosed in connection with FIGS. 1 to 19.

In light of the present disclosure and the above aspects, it is therefore an advantage of the present disclosure to provide an ultra-wideband antenna that operates between 850 MHz to 6 GHz.

It is a further advantage of the present disclosure to provide an ultra-wideband antenna that operates between 850 MHz to 6 GHz in a relatively compact housing for mobile deployment for drone detection and interdiction.

The advantages discussed herein may be found in one, or some, and perhaps not all of the embodiments disclosed herein. Additional features and advantages are described herein, and will be apparent from, the following Detailed Description and the figures.

### BRIEF DESCRIPTION OF THE FIGURES

FIG. 1 is a diagram of an exploded view of a cylindrically profiled ultra-wideband antenna, according to an example embodiment of the present disclosure.

FIG. 2 is a diagram of a pre-formed CPAB of the cylindrically profiled ultra-wideband antenna of FIG. 1, according to an example embodiment of the present disclosure.

FIGS. 3 and 4 are diagrams of a PCB of a FLPCBA of the cylindrically profiled ultra-wideband antenna of FIG. 1, according to an example embodiment of the present disclosure.

FIG. 5 is a diagram of a top perspective view of the cylindrically profiled ultra-wideband antenna of FIG. 1, according to an example embodiment of the present disclosure.

FIG. 6 is a diagram of a plan view of the cylindrically profiled ultra-wideband antenna of FIG. 1, according to an example embodiment of the present disclosure.

FIG. 7 is a diagram of a bottom perspective view of the cylindrically profiled ultra-wideband antenna of FIG. 1, according to an example embodiment of the present disclosure.

FIG. 8 is a diagram of a bottom-up view of the cylindrically profiled ultra-wideband antenna of FIG. 1, according to an example embodiment of the present disclosure.

FIGS. 9 and 10 are diagrams of side perspective views of the cylindrically profiled ultra-wideband antenna of FIG. 1, according to an example embodiment of the present disclosure.

FIG. 11 is a diagram of a back view of the cylindrically profiled ultra-wideband antenna of FIG. 1, according to an example embodiment of the present disclosure.

FIG. 12 is a diagram of a front view of the cylindrically profiled ultra-wideband antenna of FIG. 1, according to an example embodiment of the present disclosure.

FIGS. 13 to 18 show diagrams that are illustrative of radiation patterns of the cylindrically profiled ultra-wideband antenna of FIG. 1, according to example embodiments of the present disclosure.

FIG. 19 shows a diagram that is illustrative of the antenna deployed in a drone detection environment, according to an example embodiment of the present disclosure.

### DETAILED DESCRIPTION

The present disclosure relates in general to a cylindrically profiled ultra-wideband antenna. The cylindrically profiled ultra-wideband antenna disclosed herein includes Feed Launch Printed Circuit Board (“PCB”) Assembly (“FLPCBA”) and a connected or integrated Cylindrically Profiled Antenna Body (“CPAB”). The example CPAB disclosed herein includes a flat section and wings that are curved to form a semi-circular or cylindrical shape. The flat section of the CPAB includes a planar sheet having a tapered slot, a cavity, and a linear opening connected to the slot. The planar sheet includes or is connected to the two wings, which are formed by being symmetrically folded around a cylindrical shape.

The FLPCBA includes two PCBs or supports that sandwich the flat section of the CPAB. At least one of the PCBs includes an etched copper sheet or layer that form a tapered slot that opens into a round cavity section. The FLPCBA is positioned to be co-planar with the flat section of the cylindrically-profiled antenna body. Additionally, the tapered slot is centered on the FLPCBA and is aligned to match the mirrored tapered slot of the cylindrically-profiled antenna body. The combination of the FLPCBA and the CPAB provides a bandwidth that ranges from 850 MHz and 6 GHz with no measurable matching transition over the frequency range.

The example cylindrically profiled ultra-wideband antenna is configured to fit within a cylindrical housing having a diameter between 50 millimeters (“mm”) to 1000 mm, preferably between 75 to 125 mm and a length between 200 mm to 1000 mm, preferably around 250 mm. As such, the disclosed antenna can be carried by a human operator or installed on mobile security vehicles for UAV detection/neutralization.

As described herein, the example cylindrically profiled ultra-wideband antenna is configured to operate in a frequency range between 850 MHz to 6 GHz. In some embodiments, the cylindrically profiled ultra-wideband antenna is configured to emit a relatively high-frequency electromagnetic signal or wave to interrupt and/or disrupt the RF communications and/or GPS signals for a paired or autonomous device. As disclosed herein, the device may include a UAV, such as any commercial or military drone. In some embodiments, the cylindrically profiled ultra-wideband antenna is alternatively or additionally configured to detect a presence of one or more drones by providing for the detection of signals between 850 MHz to 6 GHz. In some embodiments, the cylindrically profiled ultra-wideband antenna is configured in applications needing wideband antennas with an impedance and radiation bandwidth ranging from 900 MHz up to 6 GHz, with an emphasis on the following bands: 863-870 MHz, 902-928 MHz, 1.2-1.6 GHz, 2.4-2.5 GHz and 5.7-5.9 GHz. In some embodiments, the cylindrically profiled ultra-wideband antenna is configured to have a gain of at least 5 dBi and a maximum voltage standing wave ratio (“VSWR”) of 2:1.

While the disclosure herein relates to UAV detection and/or neutralization, it should be appreciated that the cylindrically profiled ultra-wideband antenna may be used for other applications. For example, the cylindrically profiled ultra-wideband antenna may be used for radar tracking of a target. The cylindrically profiled ultra-wideband antenna may also be used also be used for wideband communications. The cylindrically profiled ultra-wideband antenna may also transmit signals that prevent a drone from receiving navigational services such as that offered through GPS or a global navigation satellite system (“GNSS”).

### Cylindrically Profiled Ultra-Wideband Antenna Embodiment

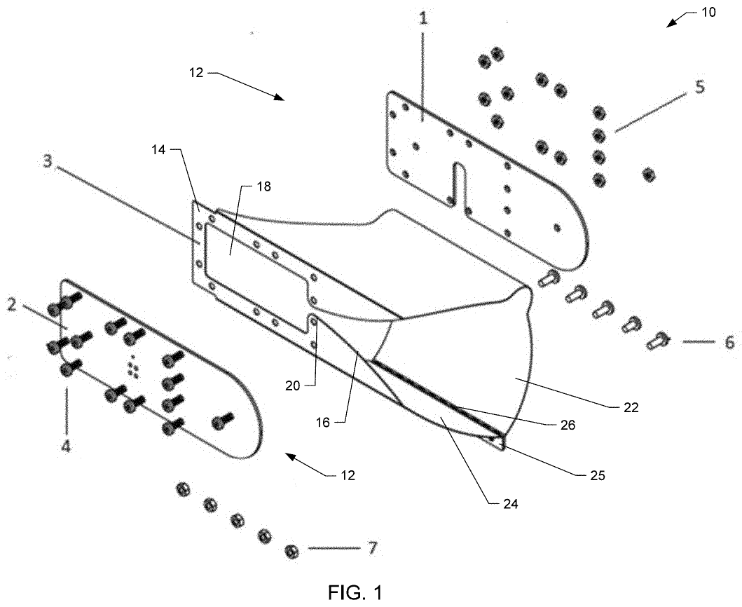

FIG. 1 is a diagram of an exploded view of a cylindrically profiled ultra-wideband antenna 10, according to an example embodiment of the present disclosure. The antenna includes a FLPBCA 12 and a CPAB 3. In the illustrated embodiment, the FLPBCA 12 includes a first PCB 1 and a second PCB 2. The PCBs 1 and 2 re configured to sandwich a flat section 14 of the CPAB 3. In other embodiments, only a single PCB is connected to the flat section 14.

The example PCBs 1 and 2 include a high dielectric strength high frequency printed circuit board material. It should be appreciated that the PCBs 1 and 2 may include any rigid non-conductive support structure or plate. The PCB 1 is provided for support of the PCB 2 and the flat section 14. The PCB 2 includes a copper sheet or layer, which is formed into a feed launch. The copper layer or sheet may be etched to form a tapered slot that opens into a round cavity section.

As shown in FIG. 1, the flat section 14 of the CPAB 3 includes a planar sheet having a tapered slot 16, a cavity 18, and a linear opening 20 connected to the slot. The PCB 2 of the FLPCBA 12 is positioned to be co-planar with the flat section 14 of the CPAB 3. Additionally, the etched copper tapered slot of the PCB 2 is centered on the FLPCBA 12 and is aligned to match the mirrored tapered slot 16 of the CPAB 3. Further, the round cavity section of the PCB 2 is aligned to fit inside of the cavity 18 of the CPAB 3. The FLPCBA 12 is uniquely designed (via copper etching) for manufacturability to maintain tight mechanical and electrical tolerances for the feed launch aspects of the antenna. The etched PCB 2 accordingly enables the cylindrically profiled ultra-wideband antenna 10 to have precise tolerances for a feed from an unbalanced feeder and mirror launch into the CPAB 3.

The PCBs 1 and 2 are connected together via screw fasteners 4 and threaded nuts 5. The fasteners 4 and nuts 5 are non-conductive, and may comprise nylon or any other non-conductive material. It should be appreciated that other connectors may be used for connecting the PCBs 1 and 2 including chemical connectors or other types of mechanical connectors.

FIG. 1 also shows that the CPAB 3 includes wings 22 and 24 that are curved to form a semi-circular or cylindrical shape. The wings 22 and 24 may be formed of copper or any other conductive material and connected together via tabs 25 at a seam 26. Mechanical screw fasteners 6 and threaded nuts 7 are provided for connecting ends of the wings 22 and 24 at the seam 26. The fasteners 6 and nuts 7 may be conductive (e.g., made of brass, steel, etc.) or alternatively may be non-conductive.

The combination of the FLPCBA 12 and the CPAB 3 provides a bandwidth that ranges from 850 MHz and 6 GHz with no measurable matching transition over the frequency range.

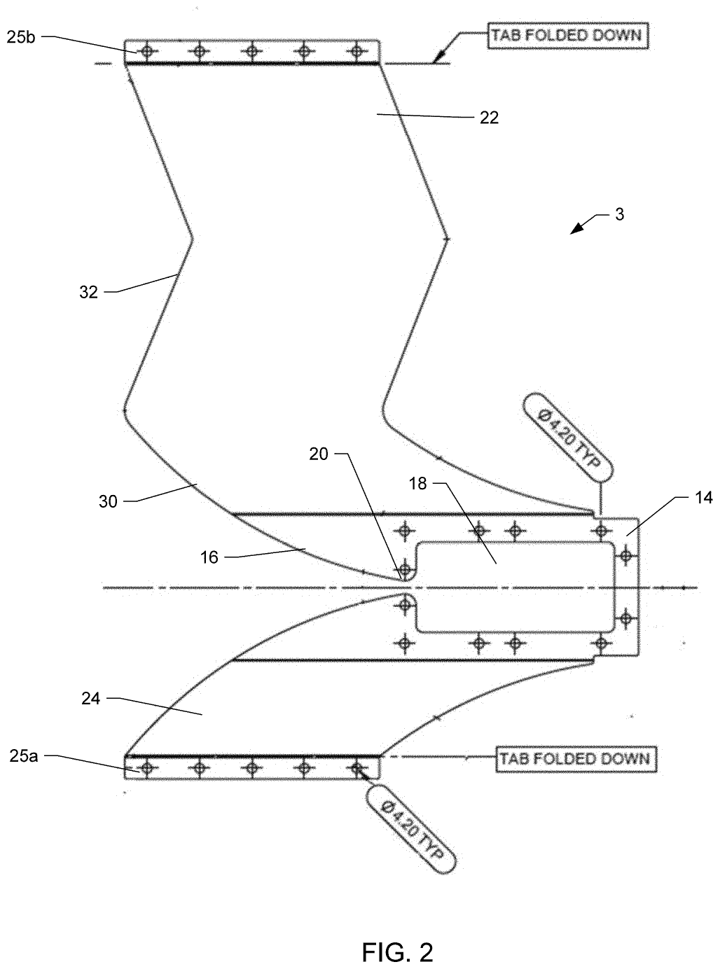

FIG. 2 is a diagram of the CPAB 3 before the wings 22 and 24 are folded, according to an example embodiment of the present disclosure. The pre-formed shape of the CPAB 3 is illustrative of the shape after being cut, for example, from a copper sheet. As shown, the wing 22 is longer than wing 24. Additionally, the wing 24 is shaped to have a forward curvature. The wing 24 includes a first section 30 that also has a forward curvature. A second section 32 of the wing 24 has a shape similar to a chevron. Tabs 25a and 25b are respectively formed at the ends of each of the wings 22 and 24. The tabs 25a and 25b are folded downward to form the seam 26, shown in FIG. 1.

FIG. 2 also shows the flat section 14, which is not bent or otherwise curved. The tapered slot 16 of the flat section 14 has a curvature that is integrally formed with the forward curvature of the wings 22 and 24. The cavity 18 of the flat section 14 is connected to the tapered slot 16 via the linear opening 20.

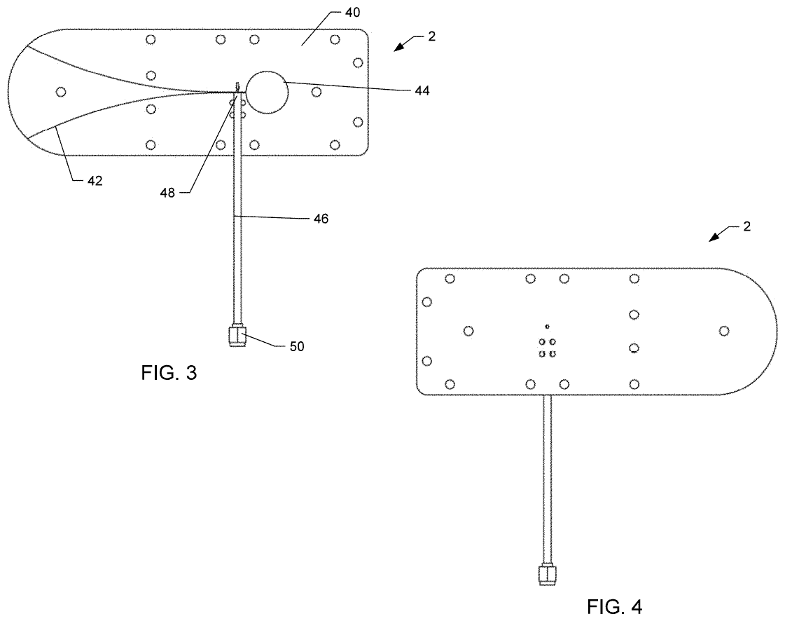

FIGS. 3 and 4 are diagrams of the PCB 2 of the FLPCBA 12, according to an example embodiment of the present disclosure. FIG. 3 shows a top side of the PCB 2 while FIG. 4 shows a bottom side of the PCB 2. As shown in FIG. 3, the PCB 2 include a copper layer or sheet 40. The top side of the PCB 2 is configured to contact a bottom side of the flat section 14 of the CPAB 3.

The copper layer or sheet 40 of the PCB 2 shown in FIG. 3 is etched or otherwise formed to create a tapered slot 42 and a cavity 44. The tapered slot 42 opens into the cavity section 44. While the cavity section 44 is shown as being round, it should be appreciated that the cavity section 44 may have other shapes, such as an oval shape, a rectangular shape, etc.

The etched copper tapered slot 42 of the PCB 2 is aligned to match the mirrored tapered slot 16 of the CPAB 3, shown in FIG. 2. For instance, a curvature of the slot 42 substantially matches a curvature of the slot 16 of the CPAB 3. Further, the cavity section 44 of the PCB 2 is aligned to fit inside of the cavity 18 of the CPAB 3.

FIG. 3 also shows a feedline 46 that is electrically connected to the copper layer 40 of the PCB 2. A first end 48 of the feedline 46 connects across the tapered slot 42. A second end 50 of the feedline 50 is connected to an antenna combining system, which provides a source of radio-frequency (“RF”) energy. In some embodiments, the feedline 46 includes a coaxial feeder cable and the second end 50 includes an RF termination connector for connection to an antenna combining system.

FIG. 4 shows a bottom side of the PCB 2. As shown, the bottom side does not include a copper layer or sheet. Instead, the bottom side includes a non-conductive circuit board or other material that provides structural rigidity for the copper layer or sheet 40 shown in FIG. 3. It should also be appreciated that the PCB 1, shown in FIG. 1 has top and bottom sides comprising a non-conductive circuit board. However, in other embodiments, at least one side of the PCB 1 includes an etched copper layer or sheet similar to the etched copper layer or sheet 40 of the PCB 2.

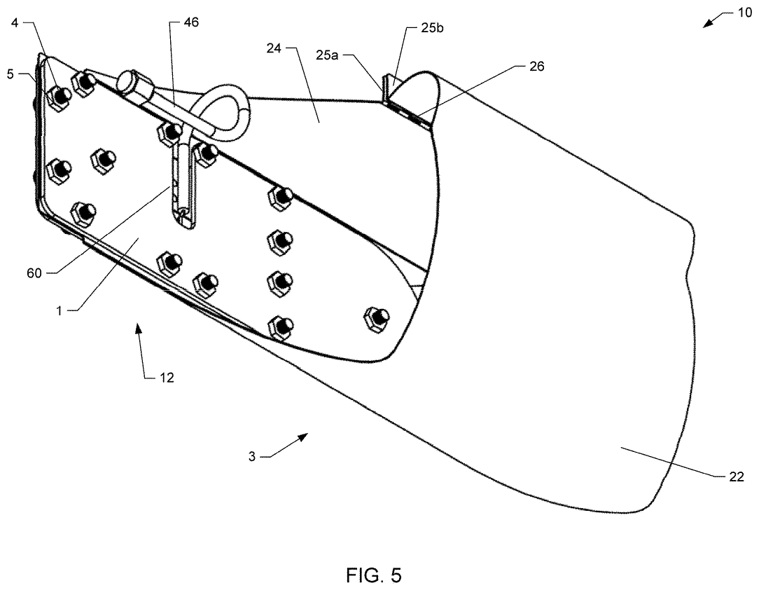

FIGS. 5 to 12 are diagrams of different views of the assembled cylindrically profiled ultra-wideband antenna 10 of FIG. 1, according to an example embodiment of the present disclosure. FIG. 5 shows a top perspective view of the cylindrically profiled ultra-wideband antenna 10. As shown, the PCB 1 includes a cutout 60 to accommodate the feedline 46 and its connection to the PCB 2. Also, as shown, the fasteners 4 and nuts 5 are connected together for securing the PCBs 1 and 2 together. As shown, the flat section 14 of the CPAB 3 is sandwiched by the PCBs 1 and 2 of the FLPCBA 12.

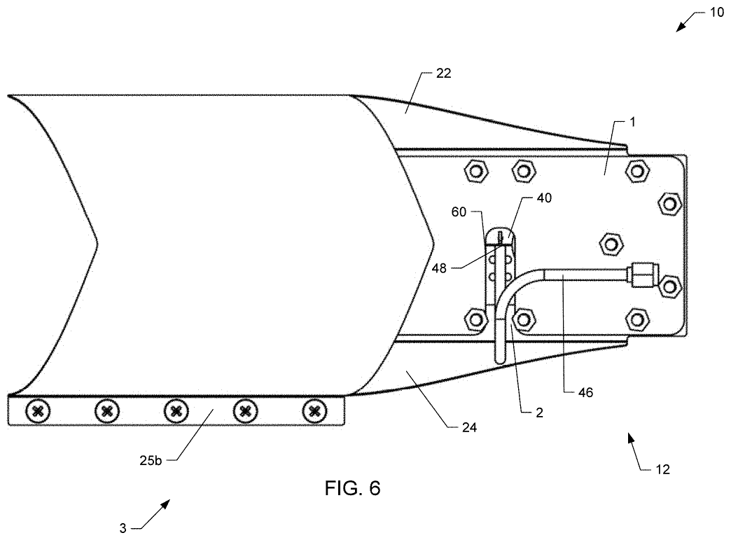

FIG. 6 shows a plan view of the cylindrically profiled ultra-wideband antenna 10. The end 48 of the feedline 46 connected to the copper layer or sheet 40 of the PCB 2. The feedline 46 is formed to such that a first portion is provided perpendicular with respect to an orientation of the cylindrically profiled ultra-wideband antenna 10, while a second portion as a parallel orientation. As shown in FIG. 5, the feedline 46 also rises from a surface of the PCB 1.

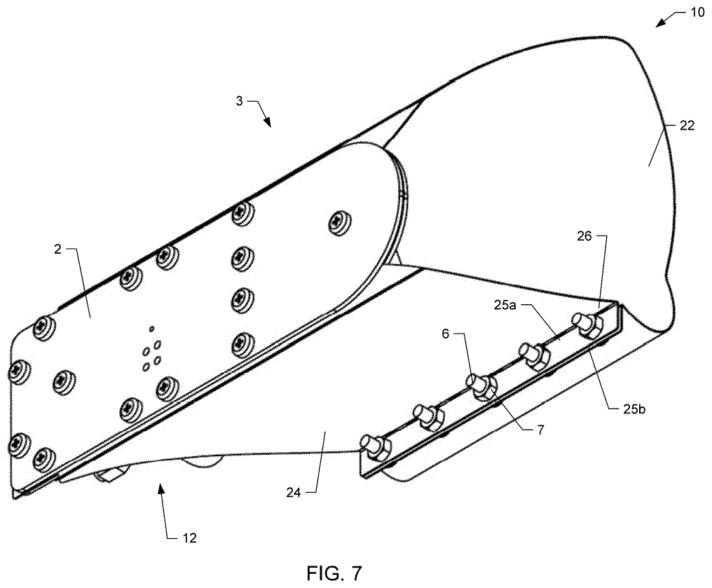

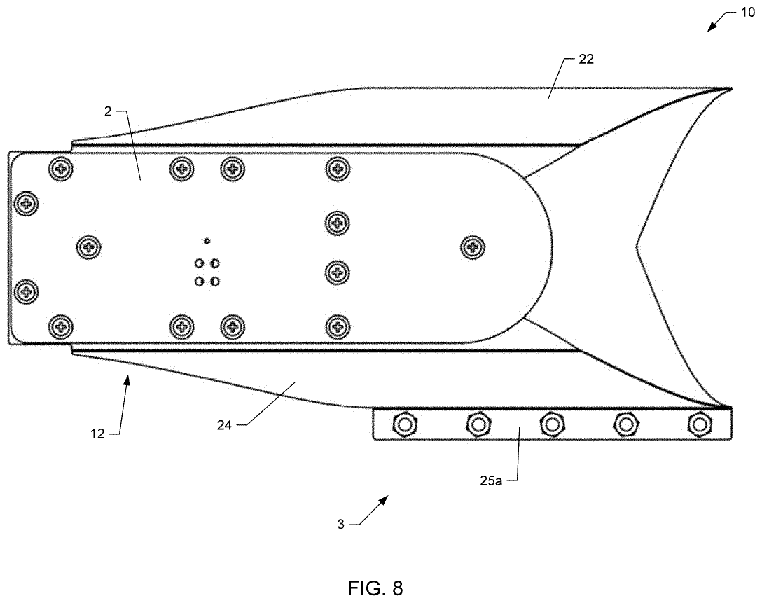

FIG. 7 shows a bottom perspective view of the cylindrically profiled ultra-wideband antenna 10, while FIG. 8 shows a bottom-up view of the cylindrically profiled ultra-wideband antenna 10. A bottom side of the PCB 2 is shown. Additionally, the fasteners 6 are shown connected to the nuts 7, thereby connecting the tabs 25a and 25b of the respective wings 22 and 22.

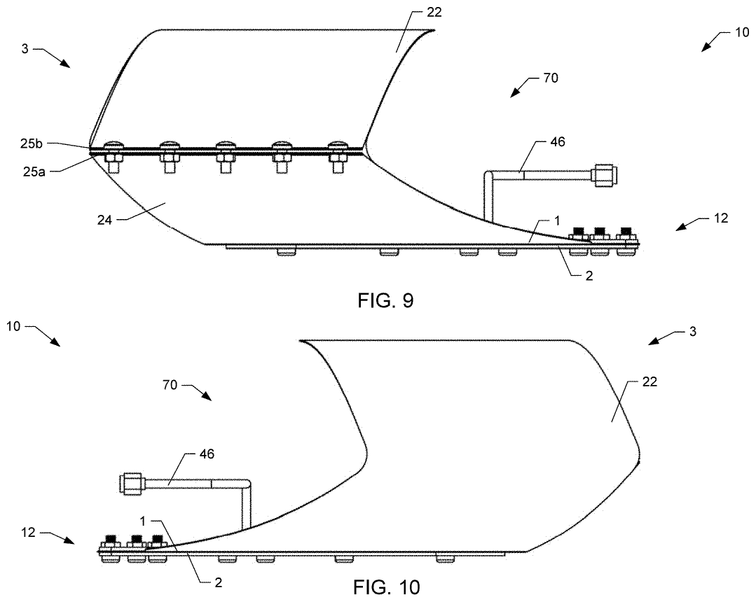

FIGS. 9 and 10 are diagrams of side perspective views of the cylindrically profiled ultra-wideband antenna 10 of FIG. 1, according to an example embodiment of the present disclosure. In the illustrated example, the wings 22 and 24 are positioned to be at a back end of the CPAB 3, thereby creating an open space 70. This configuration enables directed high-frequency launches of RF signals via the cavity 44 through the FLPCBA 12. The front-positioning of the FLPCBA 12 enables substantially uniform-spherical lower frequency launches of RF signals, without experiencing affects from the wings 22 and 24 of the CPAB 3.

FIGS. 9 and 10 also show the wings 22 and 24 having side edges that form a v-shape or concave-shape having a vertex at the tabs 25 and a location opposite the tabs 25. The v-shape or concave-shape may optimize the forward launch of antenna patterns across the full wide frequency range. It should be appreciated that in other examples, the wings 22 and 24 may have straight sides, forming more of a traditional cylinder. In yet other examples, the wings 22 and 24 may have edges in a chevron pattern or have a semi-circular repeating edge. The illustrated cylindrically profiled ultra-wideband antenna 10 has a length between 200 millimeters (“mm”) and 1000 mm.

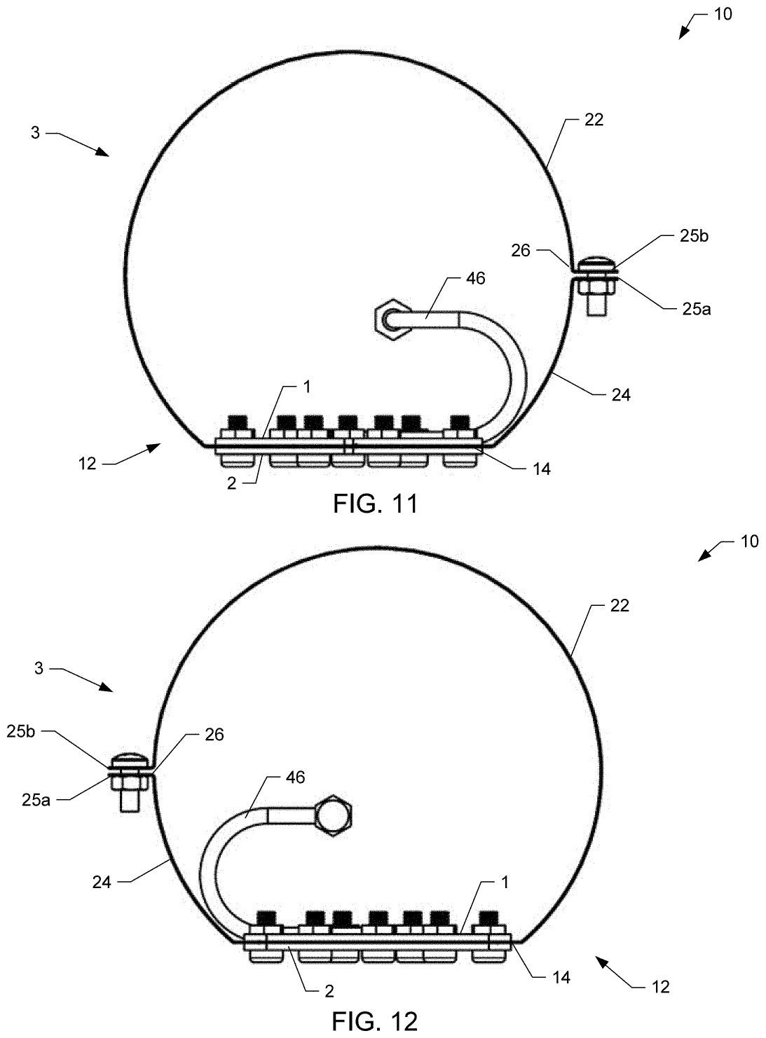

FIG. 11 is a diagram of a back view of the cylindrically profiled ultra-wideband antenna 10 of FIG. 1, according to an example embodiment of the present disclosure. FIG. 12 is a diagram of a front view of the cylindrically profiled ultra-wideband antenna 10 of FIG. 1, according to an example embodiment of the present disclosure.

This diagrams show the positioning of the wings 22 and 24 with each other to form a semi-circular or semi-oval shape for the antenna 10. The flat section 14, sandwiched by the PCBs 1 and 2, forms a flat side for the semi-circular or semi-oval shape. In this example, the wing 22 is shown as covering about 140° to 160° of the semi-circular shape while the wing 24 covers 20° to 40°, with the seam 26 there between. In other examples, the wings 22 and 24 may each cover 90°. In yet other examples, a single wing may be used instead of two separate wings. The illustrated cylindrically profiled ultra-wideband antenna 10 has a diameter that is between 50 mm and 1000 mm.

### Example Radiation Patterns

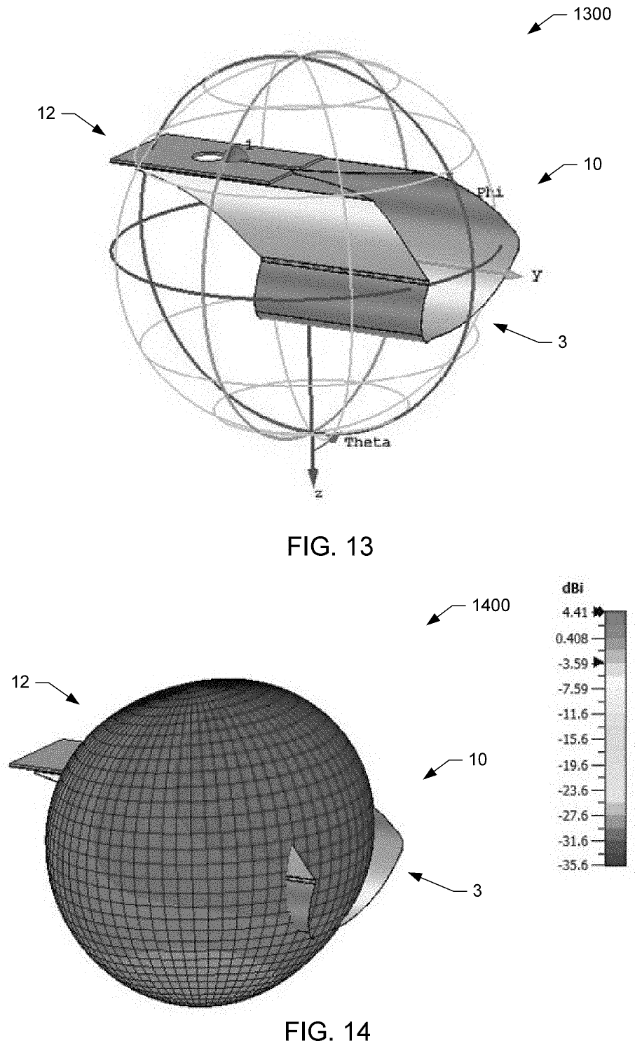

FIG. 13 shows a diagram of reference graph 1300 for radiation patterns for the example antenna 10 of FIG. 1, according to an example embodiment of the present disclosure. In the illustrated example, the FLPCBA 12 with the slot cavity is placed in an upper-left quadrant of a spherical grid. In addition, the three-dimensional CPAB 3 is placed about a right side of the spherical grid such that a center of the antenna 10 is placed within a center of the grid.

As shown in FIGS. 14 to 18, the spherical grid provides a far field radiation pattern measured in dBi (gain) for different frequencies. FIG. 14 shows a diagram of a radiation pattern 1400 for the example antenna 10 of FIG. 1, according to an example embodiment of the present disclosure. The example antenna 10 outputs a 900 MHz signal in this embodiment. As shown, the CPAB 3 causes a substantially, uniform spherical pattern to be generated with a gain between 3 and 4.5, and a total effectiveness of around −1.383 dB.

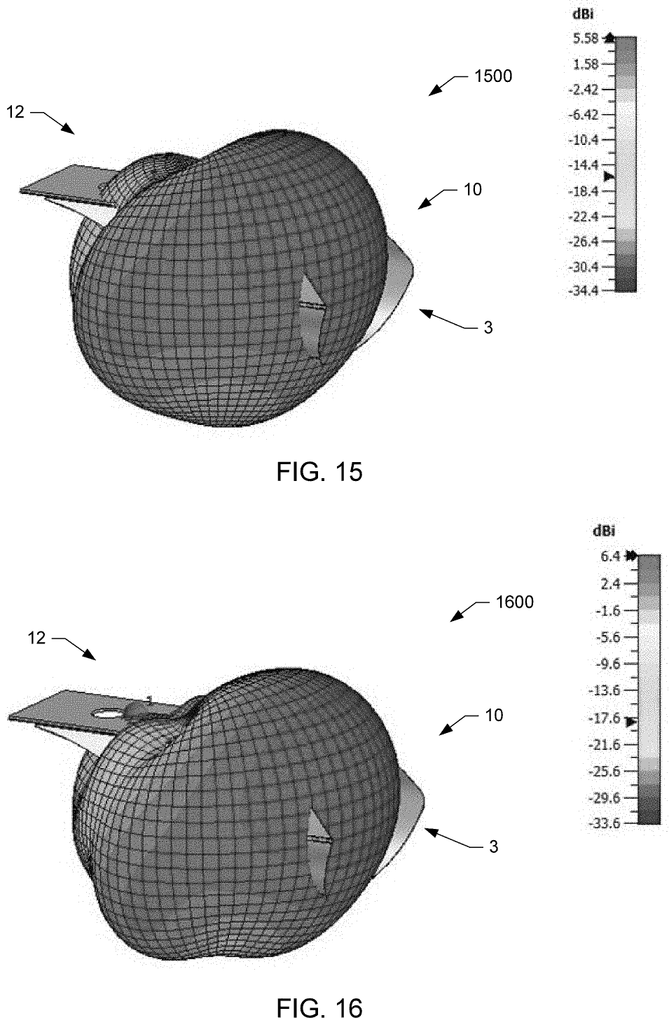

FIG. 15 shows a diagram of a radiation pattern 1500 for the example antenna 10 of FIG. 1, according to an example embodiment of the present disclosure. The example antenna 10 outputs a 1.2 GHz signal in this embodiment. As shown, there is partial uniform spherical pattern that is generated by the CPAB 3. The sphere collapses by the cavity of the FLPCBA 12, which begins to contribute a high-frequency directivity pattern. The radiation pattern 1500 has better directivity compared to the radiation pattern 1400, and a greater gain of about 4 to 5.6 dbi. Further, at 1.2 GHz, the antenna 10 has a total effectiveness of around −0.92 dB.

FIG. 16 shows a diagram of a radiation pattern 1600 for the example antenna 10 of FIG. 1, according to an example embodiment of the present disclosure. In this example, the example antenna 10 outputs a 1.6 GHz signal. As shown, there is less of a spherical pattern generated by the CPAB 3. The radiation sphere further collapses by the cavity of the FLPCBA 12, which provides a high-frequency directivity pattern. The radiation pattern 1600 has better directivity compared to the radiation patterns 1400 and 1500, and a greater gain of about 4.5 to 6.4 dbi. Further, at 1.6 GHz, the antenna 10 has a total effectiveness of around −0.8 dB.

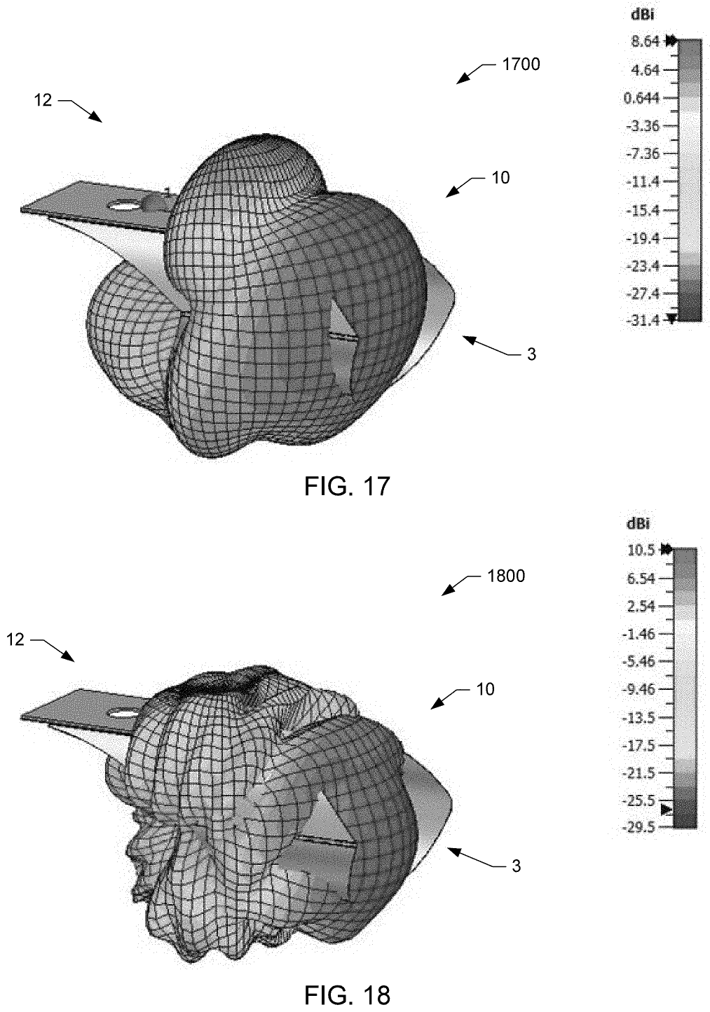

FIG. 17 shows a diagram of a radiation pattern 1700 for the example antenna 10 of FIG. 1, according to an example embodiment of the present disclosure. In this example, the example antenna 10 outputs a 2.4 GHz signal. As shown, there is much less of a spherical pattern generated by the CPAB 3. The FLPCBA 12 provides a high-frequency directivity pattern. The radiation pattern 1700 has better directivity compared to the radiation patterns 1400 to 1600, and a greater gain of about 5 to 8.6 dbi. Further, at 2.4 GHz, the antenna 10 has a total effectiveness of around −0.75 dB.

FIG. 18 shows a diagram of a radiation pattern 1800 for the example antenna 10 of FIG. 1, according to an example embodiment of the present disclosure. In this example, the example antenna 10 outputs a 5.8 GHz signal. As shown, there is almost no spherical pattern generated by the tCPAB 3. The FLPCBA 12 provides a high-frequency directivity pattern. The radiation pattern 1800 has better directivity compared to the radiation patterns 1400 to 1700, and a greater gain of about 6 to 10.5 dbi. Further, at 5.8 GHz, the antenna 10 has a total effectiveness of around −0.9 dB.

### Deployment Example

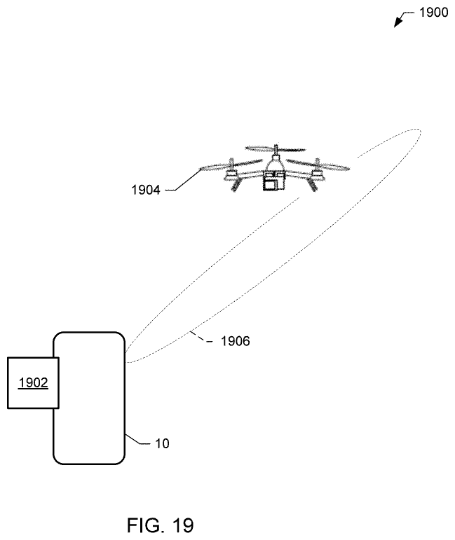

FIG. 19 shows a diagram that is illustrative of the example ultra-wideband antenna 10 deployed in a drone detection environment 1900, according to an example embodiment of the present disclosure. In the illustrated example, the antenna 10 is electrically coupled to a detection and deterrent system 1902. The system may include any sensors for detecting a location of a drone 1904. The system may also include circuitry/power for producing low and/or high-frequency signals for neutralizing the drone 1904. The signals may include high-frequency signals that are configured to interfere with GPS, communication, or electronics of the drone 1904. In some instances, the interference may cause the drone 1904 to land for detainment.

In the example, the system 1902 transmits a signal to the antenna 10, which radiates the signal as high-frequency electromagnetic waves 1906. When directed at the drone 1904, the electromagnetic waves 1906 disable the drone 1904, causing the drone 1904 to land. In some instances, the system 1902 may control one or more platforms to directionally steer or point the antenna 10 at the drone 1904, including as the drone 1904 descends and/or after the drone has landed. The signal 1906 may interfere with, for example, Wi-Fi bands, cellular bands, and/or GPS bands, thereby interfering in the communication and/or operation of the drone 1904.

Additionally or alternatively, the antenna 10 may be configured to detect signals in, for example, the Wi-Fi bands, cellular bands, and/or GPS bands. Detection of these signals may be used for detecting and/or determining a location of the drone 1904. The system 1902 may determine a heading and/or direction of the drone 1904, which may be used to steer or otherwise point the antenna 10 at the drone 1904 when the electromagnetic waves 1906 are launched.

### CONCLUSION

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An antenna apparatus comprising:
a feed launch printed circuit board (“PCB”) assembly having a tapered slot opening into a round cavity section; and
cylindrically-profiled antenna body including a flat section and wings that are curved to form a semi-circular or cylindrical shape,
wherein the feed launch PCB assembly is co-planar with the flat section of the cylindrically-profiled antenna body, and
wherein the tapered slot is centered on the feed launch PCB assembly and aligned to match a mirrored tapered slot of the cylindrically-profiled antenna body.

2. The apparatus of claim 1, wherein the feed launch PCB assembly includes a first PCB and a second PCB that sandwich at least a portion of the flat section of the cylindrically-profiled antenna body.

3. The apparatus of claim 2, wherein the tapered slot and the round cavity section are formed from etched copper on at least one of the first PCB and the second PCB.

4. The apparatus of claim 2, wherein the first PCB is connected to the second PCB via fasteners positioned along at least one edge of the feed launch PCB assembly.

5. The apparatus of claim 4, wherein the fasteners are non-conductive.

6. The apparatus of claim 4, wherein the tapered slot of the feed launch PCB assembly is defined by two symmetrical wings that are co-planar with the round cavity section.

7. The apparatus of claim 1, further comprising a feedline electrically connected to the feed launch PCB assembly.

8. The apparatus of claim 1, wherein the feedline is additionally connected to a source of radio-frequency (“RF”) energy.

9. The apparatus of claim 7, wherein the feedline includes a coaxial feeder cable.

10. The apparatus of claim 1, wherein the combination of the feed launch PCB assembly and the cylindrically-profiled antenna body provides a radiation bandwidth between 850 MHz and 6 GHz.

11. An antenna apparatus comprising:
a feed launch assembly having a tapered slot; and
cylindrically-profiled antenna body including a flat section and wings that are curved to form a semi-circular or cylindrical shape,
wherein the feed launch assembly is co-planar with the flat section of the cylindrically-profiled antenna body, and
wherein the tapered slot of the feed launch assembly is aligned to match a tapered slot of the cylindrically-profiled antenna body.

12. The apparatus of claim 11, wherein the wings include a first wing having a first end connected to or integrally formed with the flat section and a second end with a first tab, and a second wing having a first end connected to or integrally formed with the flat section and a second end with a second tab.

13. The apparatus of claim 12, wherein the first tab of the first wing is mechanically connected to the second tab of the second wing.

14. The apparatus of claim 11, wherein the cylindrically-profiled antenna body has a diameter that is between 50 millimeters (“mm”) and 1000 mm and a length between 200 mm and 1000 mm.

15. The apparatus of claim 11, wherein the feed launch assembly includes a first rigid plate and a second rigid plate that sandwich at least a portion of the flat section of the cylindrically-profiled antenna body.

16. The apparatus of claim 15, wherein the tapered slot is formed from etched copper on at least one of the first rigid plate and the second rigid plate.

17. The apparatus of claim 15, wherein at least one of the first rigid plate and the second rigid plate includes a cavity section that is connected via an opening to the tapered slot.

18. The apparatus of claim 11, wherein the combination of the feed launch assembly and the cylindrically-profiled antenna body provides a radiation bandwidth between 850 MHz and 6 GHz.

19. The apparatus of claim 11, further comprising a feedline electrically connected to the feed launch assembly.

20. The apparatus of claim 19, wherein the feedline is electrically coupled to a drone detection and deterrent system.
